(19) United States
(12) Patent Application Publication
(10) Pub. No.: US 2006/0046524 A1
(43) Pub. Date: Mar. 2, 2006

(54) [POWER SWITCHING MODULE]

(75) Inventor: Chun-Hung Chen, TAIPEI (TW)

Correspondence Address: D-WAY SCIENTIFIC CO., LTD, 2F-4. NO. 148, SEC. 4, CHUNG HSIAO E. ROAD, TAIPEI, TW

(73) Assignee: D-WAV SCIENTIFIC CO., LTD, JUBEI CITY (TW)

(21) Appl. No.: 10/711,216

(22) Filed: Sep. 2, 2004

(51) Int. Cl. H01R 12/00

(52) U.S. Cl. 439/65

(57) ABSTRACT

A power switching module of the present invention comprises a plurality of connectors, disposed on a circuit board, for supplying power and transmitting signals, wherein the connectors comprises power sockets and signal sockets; a power adaptor, disposed on the circuit board, electrically connected to the power sockets of said connectors; and a signal adaptor, disposed on the circuit board, electrically connected to the signal sockets of said connectors. Thus, the motherboard set the single set of the signal plug will not occupy the space and therefore adequate space is available for installing electronic components over the motherboard.

### BACKGROUND OF THE INVENTION

1. The Field of the Invention

The present invention relates to a power switching module, and more particularly to a power switching module comprising a plurality of connectors sharing a common circuit loop for simultaneously supplying power and transmitting signal.

2. Description of Related Art

In the present information technology era, a variety of high-tech electronic products are being developed for meeting our modern life style. Improvement of high-tech products has led to improvement of electronic products. Nowadays, electronic products are being designed to be multi-functional, multi-purpose and multi-adaptable of devices to add value to electronic products. Generally, a signal connector, for example, a USB connector, IEEE1394 connector and the like, is connected to a motherboard for connecting to a variety of peripheral devices such as external card reader, video camera, digital camera, scanner, disk, CD driver and the like so as to provide multi-functions. The peripheral devices are generally equipped with their own power cords and signal wires for operation thereof. Because the connector on the motherboard must transmit signal and supply power at the same time, supply of power is relatively weak. And if a plurality of peripheral devices is connected to the motherboard, supply of power is relatively weaker and affects transmission of signal. The influence of supply of power and transmission of signal would cause inconvenience.

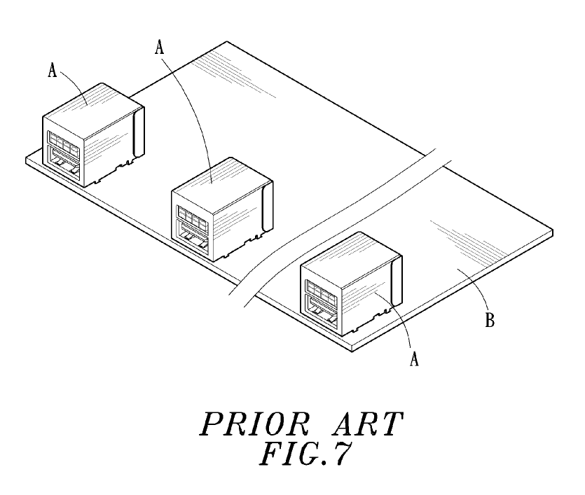

Referring to FIG. 7, a conventional USB connector A comprises a power socket and a signal socket is positioned on a motherboard B. The connector A is adapted for connecting only one peripheral device. Even though a plurality of connectors A may be used for connecting a plurality of peripheral devices, however, this would disadvantageously increase space occupation on the edge of the motherboard B and thereby reducing the space for installing other electronic components on the edge of the motherboard B.

Accordingly, the conventional connector described above has the following disadvantages.

1. The motherboard comprises only signal plug with small power thereon, which needs large power, and does not have enough power to operate the peripheral device. Thus, this causes inconvenience to the user.

2. The connector on the motherboard can be adapted for connecting to only one peripheral device, for example, a card reader, and a user desires to use another peripheral device, such as a scanner, the user must unplug the card reader for connecting the scanner.

3. Even though a plurality of connectors may be installed on the motherboard for connecting a plurality of peripheral devices, the space occupation on the edge of the motherboard is increased and this would reduce the space on the edge of the motherboard for other electronic components and thereby adversely affect circuit design.

Accordingly, the defects of the conventional connector described above are important issues for the manufacturers in the field to improve.

### SUMMARY OF THE INVENTION

Accordingly, in the view of the foregoing, the present inventor makes a detailed study of related art to evaluate and consider, and uses years of accumulated experience in this field, and through several experiments, to create a new power switching module. The present invention provides an innovated cost effective power switching module capable of connecting to both power plugs and signal plugs of peripheral devices. Thus, the power switching module of the present invention is capable of providing greater convenience to the user.

According to an aspect of the present invention, the power switching module comprises a plurality of connectors, a power adaptor and a signal adaptor on a circuit board. The connector comprises power sockets and signal sockets. The power sockets of the connectors share the circuit loop of the circuit board and are electrically connected to the power adaptor and the signal sockets of the connectors also share the circuit loop on the circuit board and are electrically connect to the signal adaptor. Accordingly, the power switching module needs a single set of power adaptor and a single set of signal adaptor, and the power adaptor can be connected to the power supply and the signal adaptor can be connected to the motherboard. Thus, the space occupation by the power switching module is minimized and therefore enough space is available for installing electronic components over the motherboard.

According to another aspect of the present invention, the power switching module comprises a plurality of connectors with power and signal sockets for adapting a plurality of power and signal plugs of the peripheral devices for simultaneously supplying power and transmitting signal.

### BRIEF DESCRIPTION OF THE INVENTION

For a more complete understanding of the present invention, reference will now be made to the following detailed description of preferred embodiments taken in conjunction with the following accompanying drawings.

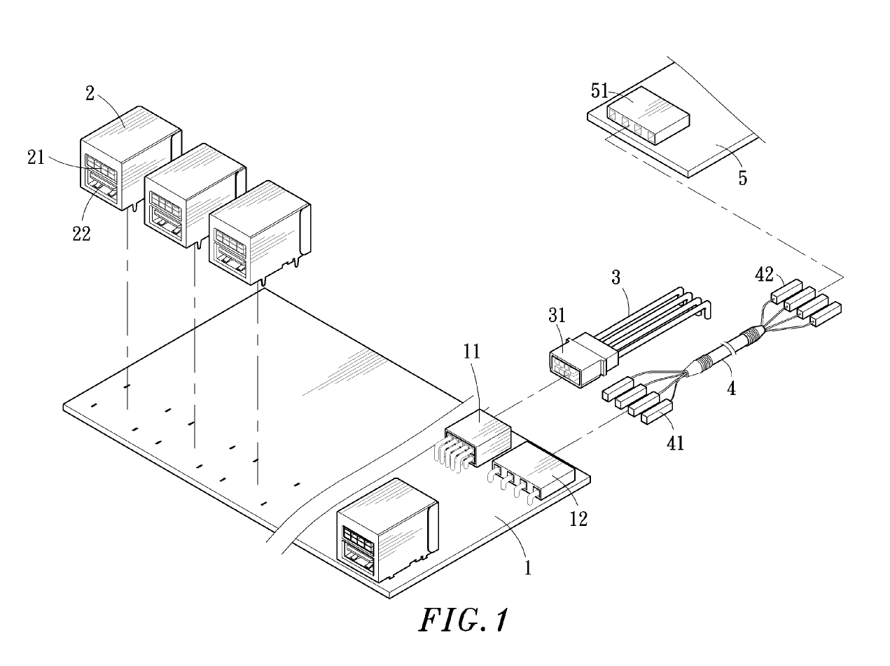

FIG. 1 is an exploded view of a power switching module according to an embodiment of the present invention.

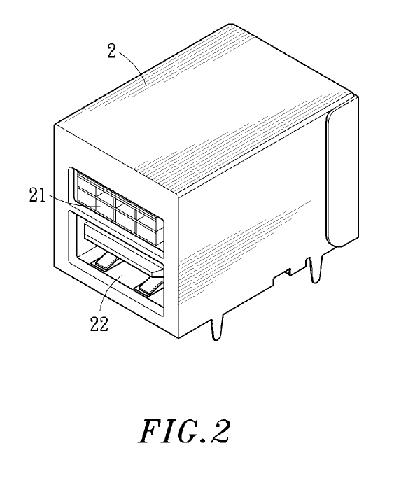

FIG. 2 is an elevational view of a connector according to an embodiment of the present invention.

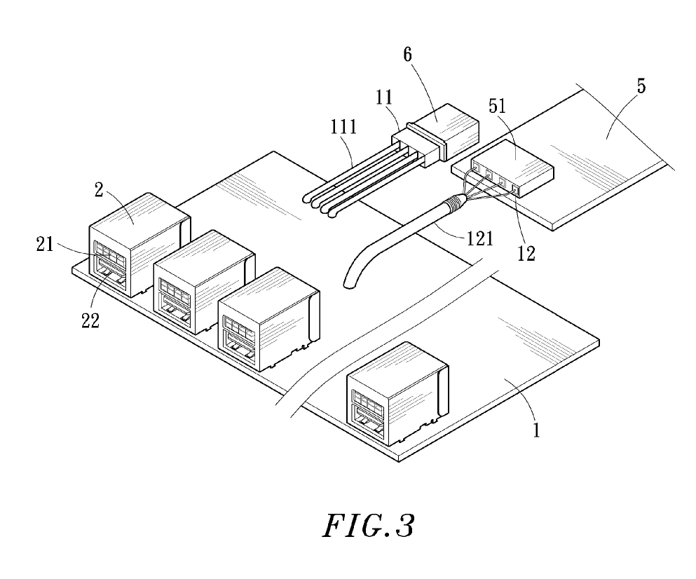

FIG. 3 is an elevational view of a power switching module according to a preferred embodiment of the present invention.

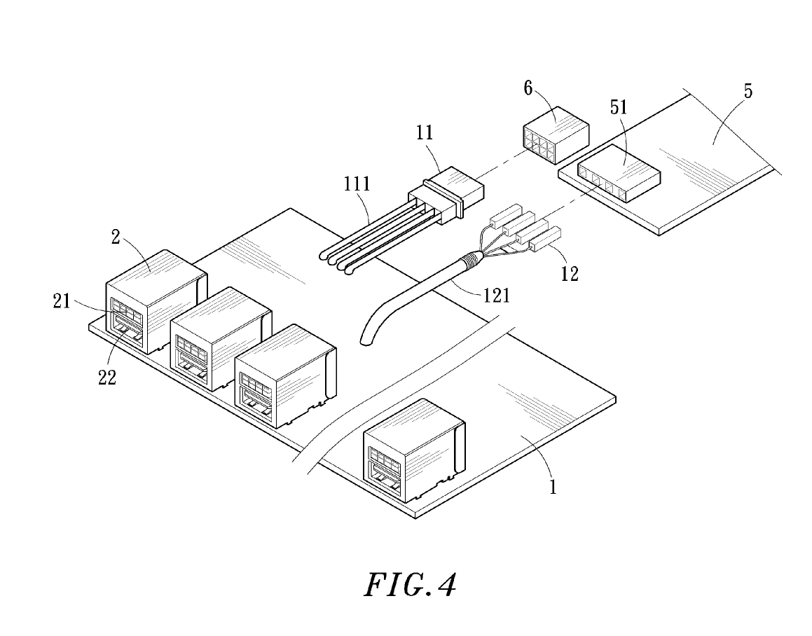

FIG. 4 is an exploded view of a power switching module according to a preferred embodiment of the present invention.

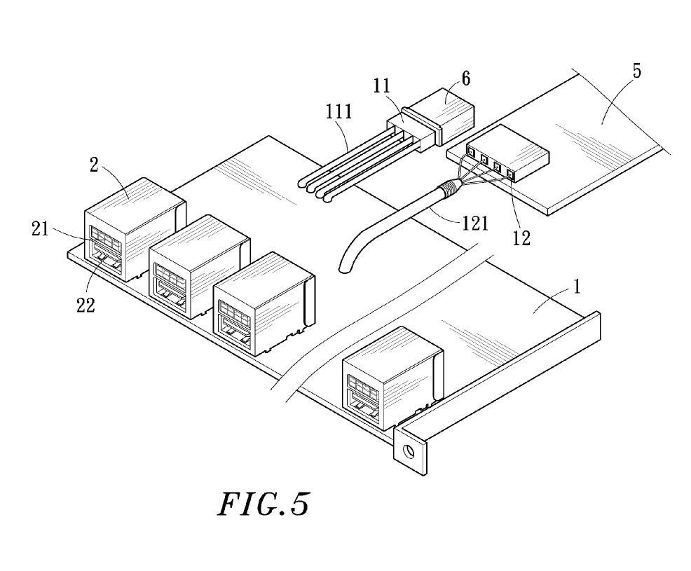

FIG. 5 is an elevational view of a power switching module according to another embodiment of the present invention.

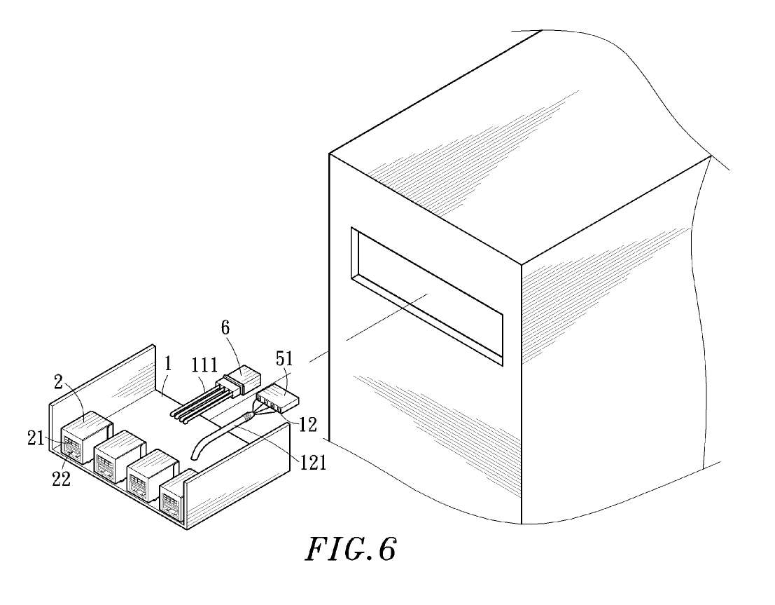

FIG. 6 is an exploded view of a power switching module according to other embodiment of the present invention.

FIG. 7 is an elevation view of a conventional connector on a motherboard.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

Referring to FIGS. 1, 2 and 3, the power switching module of the present invention comprises a circuit board 1, a power adaptor 11, a signal adaptor 12 and a plurality of connectors 2. The circuit board 1 comprises a circuit comprising a power loop and a signal loop (not shown). The power loop of the circuit board 1 is electrically connected to the power adaptor 11 and the signal loop is electrically connected to the signal adaptor 12. Thus a power plug 31 of an external power cord 3 can be plugged into the power adaptor 11 of the circuit board 1, and the power cord 3 can be connected to the device for supplying power. A signal plug 41 of an external signal wire 4 can be plugged into signal adaptor 12 of the circuit board 1, and a switching socket 42 on other side of the external signal wire 4 can be connected to a signal plug 51 of the motherboard 5. Thus, the motherboard 5 set the single set of the signal plug 51 will not occupy the space and therefore adequate space is available for installing electronic components over the motherboard.

The above power adaptor 11 and the signal adaptor 12 can be the male or female adaptor respectively to receive the corresponding power plug 31 and the signal plug 41 that can be correspondingly female or male plug respectively.

The circuit board 1 also comprises a plurality of connectors 2 with power sockets 21 and signal sockets 22. The power sockets 21 of the plurality of the connector 2 share the power loop on the circuit board 1 and are electrically connected to the power adaptor 11 of the circuit board 1. The signal sockets 22 of the plurality of the connector 2 also share the signal loop on the circuit board 1 and are electrically connected to the signal adaptor 12 of the circuit board 1.

Referring to FIGS. 2, 3 and 4, the power adaptor 11 comprises a plurality of power cords 111 for electrically connecting to the power loop of the circuit board 1 and the signal adaptor 12 comprises a signal wire 121 for electrically connecting to the signal loop of the circuit board 1. By extending the power cords 111 out of the circuit board 1, the power adaptor 11 can be exposed to the external and is connected to a power plug 6 of the power supply. Similarly, by extending the signal wire 121 out of the circuit board 1, the signal adaptor 12 can be exposed to the external and is connected to the signal plug 51 of the motherboard 5. Thus, the circuit board 1 comprises only a set of power adaptor 11, the power cords 111, the signal adaptor 12 and the signal wire 121, and therefore the motherboard 5 requires the single set of signal plug 51. Thus, the space occupation by the connectors 2 can be effectively reduced and therefore more space is made available on the motherboard 5 for installing other electronic components.

The power socket 21 of the connectors 2 on the circuit board 1 can share the power loop on the circuit board 1 and can be electrically connected to the power adaptor 11 of the circuit board 1. The signal socket 22 of the connectors 2 can also share the signal loop on the circuit board 1 and can be electrically connected to the signal adaptor 12 of the circuit board 1. Thus, the plurality of connector 2 on the circuit board 1 can receive a plurality of peripheral devices, such as card reader, scanner, digital camera, disk, CD driver and so on, for simultaneously supplying power and transmitting signal. Additionally, the signal socket 22 of the power switching module can be SATA, ATA or a commonly used specification, for example, USB, IEEE1394 and others, to adapt the signal plug of the peripheral devices.

Referring to FIG. 5, the circuit board 1, according to another embodiment of the present invention, comprises the plurality of the connectors 2, and can be designed as a interface card for securely installing the circuit board 1 to a host for adapting a plurality of peripheral devices.

Referring to FIG. 6, the circuit board 1, according to other embodiment of the present invention, can be designed in a box shape such that the circuit board 1 can be directly inserted into the slot of the host while the plurality of the connectors 2 of the circuit board 1 remain exposed and are available on the surface of the host so that a user can connect a plurality peripheral devices to the connectors 2 on the host. Thus, the present invention provides greater convenience to the user.

The power switching module of the present invention can be directly installed on the circuit board or an integral unit comprising a shell connected to the circuit board or a motherboard for adapting a plurality of peripheral devices.

Accordingly, the power switching module of the present invention has the following advantages.

1. The power switching module comprises the single set of the power adaptor and the single set of the signal adaptor. The power adaptor is connected to the power supply and the motherboard needs the single set of the signal plug for connecting the signal adaptor, thus the space occupation on the motherboard is minimized and adequate space is available for installing electronic components over the motherboard is made available.

2. The circuit board of the power switching module comprises a plurality of connectors with the power sockets and signal sockets for adapting power plugs and signal plugs of a plurality of peripheral devices, so the user need not unplug power plug or signal plug of a peripheral device when not in use for making it available for another peripheral device. Thus, the power switching module of the present invention provides great convenience to the user.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

What is claimed is:

1. A power switching module, comprising:
a plurality of connectors, disposed on a circuit board, for supplying power and transmitting signals, wherein said connectors comprises power sockets and signal sockets;
a power adaptor, disposed on the circuit board, electrically connected to said power sockets of said connectors; and
a signal adaptor, disposed on said circuit board, electrically connected to said signal sockets of said connectors.

2. The power switching module according to claim 1, wherein said power sockets of said connectors share a loop of said circuit board and are electrically connected to said power adaptor.

3. The power switching module according to claim 1, wherein said signal sockets of said connectors share a loop of said circuit board and are electrically connected to said signal adaptor.

4. The power switching module according to claim 1, wherein said signal sockets of said connectors comprises a SATA socket.

5. The power switching module according to claim 1, wherein said signal sockets of said connectors comprises an USB socket.

6. The power switching module according to claim 1, wherein said circuit board comprises power cords for electrically connecting to said power adaptor.

7. The power switching module according to claim 1, wherein said circuit board comprises a signal wire for electrically connecting to said signal adaptor.
